(19) United States
(12) Patent Application Publication
(10) Pub. No.: US 2008/0113252 A1
(43) Pub. Date: May 15, 2008

(54) Fuel Cell System

(76) Inventors: Katsuhiko Yamamoto, Aichi (JP); Osamu Yumita, Shizuoka (JP); Naoki Kanie, Aichi (JP); Naohiro Yoshida, Aichi (JP)

Correspondence Address: KENYON & KENYON LLP, 1500 K STREET N.W., SUITE 700, WASHINGTON, DC, 20005, US

(21) Appl. No.: 11/792,094

(22) PCT Filed: Dec. 13, 2005
(86) PCT No.: PCT/JP05/23217

§ 371 Date: Jun. 1, 2007

(30) Foreign Application Priority Data
Dec. 15, 2004 (JP) 2004-362463

(51) Int. Cl. H01M 8/02; H01M 8/04

(52) U.S. Cl. 429/38; 429/22

(57) ABSTRACT

It is an object to provide a simple fuel cell system and to provide a fuel cell system capable of reducing the amount of consumption of fuel gas at the time of completion of operation. A fuel cell system includes a supply piping from a fuel gas supply source storing fuel gas to a gas inlet of a fuel cell and a circulation piping from a gas outlet of the fuel cell to a junction at which the circulation piping joins the supply piping. A regulating valve and a shut-off valve are disposed on the upstream side of the junction in the supply piping. A portion on the downstream side of the junction in the supply piping and the circulation piping are in constant communicated.

### TECHNICAL FIELD

The present invention relates to a fuel cell system for circulating fuel gas discharged from a fuel cell back to the fuel cell.

### BACKGROUND ART

A fuel cell system, which circulating hydrogen gas (surplus hydrogen) as fuel gas from a fuel cell to the fuel cell, is widely known (for example, refer to patent documents 1 and 2). A fuel gas piping line for this type of fuel cell system includes a supply piping from a fuel gas supply source such as a high pressure tank to a gas inlet of the fuel cell and a circulation piping from a gas outlet of the fuel cell to a junction at which the circulation piping joins the supply piping. In other words, the gas circulation system for circulating hydrogen gas to the fuel cell includes the circulation piping and a portion on the downstream side of the junction in the supply piping.

For example, in patent document 1, a shut-off valve and a regulating valve are disposed in order from the fuel gas supply source side on the upstream side of the junction in the supply piping, and a pump and a check valve are disposed in the circulation piping. In patent document 2, a plurality of shut-off valves are disposed in gas circulation piping such as on the gas inlet side and the gas outlet side, in addition to the above configuration.

### [Patent document 1] Japanese Patent Laid-Open No. 2004-22198 (FIG. 1)

### [Patent document 2] Japanese Patent Laid-Open No. 2002-216812 (FIG. 4)

### DISCLOSURE OF THE INVENTION

A fuel cell system closes a shut-off valve on the fuel gas supply source side to stop the supply of hydrogen gas from a fuel gas supply source at the end of the operation of the fuel cell system. Just after the closing of the shut-off valve, the hydrogen gas pressure on the anode side differs from the oxidant gas pressure on the cathode side. If the pressure difference (differential pressure between electrodes) is large, however, it may induce the release of hydrogen gas to the outside due to deterioration of a fuel cell or a cross leakage therein. Therefore, it is desirable to decrease the hydrogen gas pressure on the anode side in order to reduce the differential pressure between electrodes at the end of the operation.

Where the hydrogen gas pressure is reduced in the configuration disclosed in patent document 1, it is conceivable that the pump continues to be driven at the end of the operation to consume hydrogen gas remaining in the gas circulation system by power generation of the fuel cell. The shut-off valve, however, for stopping the supply of hydrogen gas from the fuel gas supply source is located on the upstream side of the regulating valve. Therefore, it is necessary to consume not only hydrogen gas in the gas circulation system, but also hydrogen gas from the shut-off valve to the regulating valve. Consequently, it could lead to an increase in wasteful consumption of hydrogen gas, to overcharge of a secondary battery, or to a need for a long time before completion of the operation. In addition, the check valve (switch device) is disposed in the gas circulation system, which correspondingly results in hindering an efficient circulation of hydrogen gas when driving the pump at the end of the operation.

Also in the configuration disclosed in patent document 2, the same problem as the above may occur when it is attempted to reduce the hydrogen gas pressure at the end of the operation. In addition, a plurality of shut-off valves and check valves are disposed in the gas circulation system, which correspondingly results in further hindering the circulation of the hydrogen gas. On the other hand, it is possible to decrease the amount of hydrogen gas consumed by the power generation of the fuel cell by closing two shut-off valves (on the both gas inlet and outlet sides of the fuel cell) in the gas circulation system at the end of the operation. The pump, however, cannot be driven and therefore it is difficult to generate power of the fuel cell at the rated operation pressure or lower.

Furthermore, a pressure loss of the hydrogen gas occurs at the shut-off valves or check valves in the gas circulation system when operating the fuel cell system in both patent documents. Therefore, there is a need to drive the pump in consideration of the pressure loss and to increase the RPM of the pump correspondingly, by which additional power consumption is required.

Focusing on improving the gas circulation system in view of the above problems, it is therefore an object of the present invention to provide a simple fuel cell system and to provide a fuel cell system capable of reducing the amount of consumption of fuel gas at the end of the operation.

In order to achieve the above object, a fuel cell system of the present invention has as piping lines for fuel gas: a gas circulation system connecting a gas outlet of a fuel cell to a gas inlet of the fuel, the gas circulation system circulating fuel gas from the fuel cell to the fuel cell; and a first supply passage through which new fuel gas flows from a fuel gas supply source, the supply passage connected to the gas circulation system. The fuel cell system includes: a regulating valve disposed in the first supply passage; and at least one shut-off valve disposed only in the first supply passage among the piping lines and located on the downstream side of the regulating valve.

According to this configuration, no shut-off valve is disposed in the gas circulation system and therefore it is possible to form the fuel cell system which is simplified and reduced in parts count. When operating the system, new fuel gas from the fuel gas supply source is caused to flow into fuel gas in the gas circulation system by opening the shut-off valve and fuel gas whose pressure is regulated by the regulating valve is supplied to the fuel cell. On the other hand, after end of the system operation, the flow between the first supply passage and the gas circulation system is interrupted by closing the shut-off valve and thereby the gas circulation system forms an independent closed space between the shut-off valve and the fuel cell.

This reduces the amount of fuel gas remaining in the closed space in the configuration in which the shut-off valve is disposed in the first supply passage on the downstream side of the regulating valve as in the present invention, in comparison with the conventional configuration in which the regulating valve is disposed on the downstream side of the shut-off valve. Therefore, it is possible to reduce the amount of consumption of fuel gas at the end of the operation, which improves the fuel consumption (generating efficiency) and can contribute to a reduction in operation completion time. In addition, the closed space is not provided with any shut-off valves for closing it and therefore the circulation of fuel gas can be suitably performed without being prevented. Preferably the gas circulation system is not provided with any switch devices, such as a shut-off valve or a check valve, for opening and closing the piping constituting the gas circulation system. In other words, preferably the gas circulation system has a passage in constant communication between the gas outlet and the gas inlet of the fuel cell.

To achieve the above object, another fuel cell system of the present invention includes as piping lines for fuel gas: a gas circulation system connecting a gas outlet of a fuel cell to a gas inlet of the fuel, the gas circulation system circulating fuel gas from the fuel cell to the fuel cell; and a first supply passage through which new fuel gas flows from a fuel gas supply source, the first supply passage connected to the gas circulation system. The first supply passage is provided with a regulating valve and at least one shut-off valve in order from the fuel gas supply source side; and the gas circulation system has a passage in constant communication between the gas outlet and the gas inlet of the fuel cell.

Preferably, the gas circulation system has the passage in communication between the gas outlet and the gas inlet of the fuel cell when operating and stopping the fuel cell system.

Preferably, the fuel cell system further includes: a pump for pressure-feeding fuel gas disposed in the gas circulation system; and a controller for controlling the pump and the at least one shut-off valve. The controller continues to drive the pump after closing the at least one shut-off valve and causes fuel gas in the gas circulation system to be consumed by power generation of the fuel cell at the end of the operation of the fuel cell system.

According to this configuration, the pump continues to be driven when fuel gas in the gas circulation system is consumed by the power generation of the fuel cell at the end of the operation. Therefore, it is possible to consume the fuel gas appropriately and to carry out the power generation of the fuel cell stably.

Preferably, at least one shut-off valve is disposed near a connecting point between the gas circulation system and the first supply passage.

According to this configuration, the volume of the closed space can be minimized and thereby the amount of fuel gas in the closed space can be reduced further. This allows the amount of consumption of fuel gas to be reduced further at the end of the operation.

Preferably, the fuel gas supply source is a pressure vessel storing hydrogen gas as fuel gas.

According to this configuration, hydrogen gas is stored in the pressure vessel and hydrogen gas in the pressure vessel can be pressure-regulated by the regulating valve before it is supplied to the fuel cell. Here, the pressure vessel includes not only a pressure tank storing the hydrogen gas at high pressure, but also a hydrogen storage tank internally provided with a hydrogen storage alloy.

Preferably, at least one shut-off valve includes: a first shut-off valve disposed on the downstream side of the regulating valve in the first supply passage; and a second shut-off valve disposed between the regulating valve and the fuel gas supply source.

According to this configuration, the shut-off valve between the regulating valve and the fuel gas supply source can be caused to function as a source valve for the fuel gas supply source.

Preferably, the second shut-off valve is a source valve for the fuel gas supply source.

Preferably, a plurality of regulating valves are disposed in the first supply passage.

Preferably, the gas circulation system includes a gas-liquid separator for separating anode off-gas discharged from the fuel cell into liquid and gas components.

Preferably, the gas circulation system includes an impurity remover for removing impurity components contained in anode off-gas discharged from the fuel cell.

Preferably, the gas circulation system is composed of: a first circulation path from the gas outlet to a connecting point with the first supply passage; and a second circulation path from the connecting point to the gas inlet, in communication with the first circulation path.

To achieve the above object, according to another aspect of the present invention, there is provided another fuel cell system includes: a supply piping extending from a fuel gas supply source to a gas inlet of a fuel cell; and a circulation piping extending from a gas outlet of the fuel cell to a junction at which the circulation piping joins the supply piping and causing anode off-gas discharged from the fuel cell to flow into fuel gas from the fuel gas supply source. A regulating valve and a shut-off valve that is located on the downstream side of the regulating valve are provided on the upstream side of the junction in the supply piping; and wherein a portion on the downstream side of the junction in the supply piping and the circulation piping are in constant communication with each other.

Preferably, the portion on the downstream side of the junction in the supply piping and the circulation piping are in communication with each other when operating and stopping the fuel cell system.

Preferably, the portion on the downstream side of the junction in the supply piping and the circulation piping are not provided with any switch devices for opening and closing these piping systems.

According to these configurations, similarly to the above invention, there is no switch device in the portion on the downstream side of the junction in the supply piping and the circulation piping and therefore the fuel cell system is simplified. When operating the system, the shut-off valve is opened to supply the mixed fuel gas whose pressure has been regulated by the regulating valve to the fuel cell. On the other hand, after completion of the system operation, the shut-off valve is closed to stop the supply of the fuel gas from the fuel gas supply source to the fuel cell. In this case, the portion on the downstream side of the shut-off valve in the supply piping and the circulation piping form a closed space (closed circuit) between the shut-off valve and the fuel cell.

Therefore, similarly to the above, the amount of fuel gas remaining in the closed space can be reduced in comparison with the conventional configuration. Furthermore, it is possible to reduce the amount of consumption of fuel gas at the end of the operation, which improves the fuel consumption (generating efficiency) and can contribute to a reduction in operation completion time. In addition, the closed space is not provided with any switch devices for closing it and therefore the circulation of the fuel gas can be suitably performed without being prevented.

Here, the switch devices include not only a shut-off valve, but also a check valve. Viewing the above effects from the switch devices side, as no switch devices are disposed in the portion on the downstream side of the junction in the supply piping and the circulation piping, it is possible to reduce the pressure loss of the fuel gas and to reduce the number of parts in comparison with the conventional configuration. In addition, there is no possibility that impurities that can flow into the circulation piping get caught in the switch devices, thereby improving the reliability of the fuel cell system as a whole.

Preferably, the fuel cell system further includes a pump for pressure-feeding anode off-gas disposed in the circulation piping and a controller for controlling the pump and the shut-off valve. The controller continues to drive the pump after closing the shut-off valve and causes fuel gas in the piping on the downstream of the shut-off valve to be consumed by power generation of the fuel cell at the end of the operation of the fuel cell system.

Preferably, the shut-off valve is disposed near the junction.

From another viewpoint of the present invention in view of the process of arrival at the present invention, the following can be observed.

To achieve the above object, another fuel cell system of the present invention includes as piping lines for fuel gas: a gas circulation system connecting a gas outlet of a fuel cell to a gas inlet of the fuel, the gas circulation system circulating fuel gas from the fuel cell to the fuel cell; and a passage (a first supply passage) through which new fuel gas flows from a fuel gas supply source, the passage connected to the gas circulation system. The piping lines are provided with a regulating valve and at least one shut-off valve; and at least one shut-off valve is not disposed in the gas circulation system, but disposed in the portion on the downstream side of the regulating valve in the passage (the first supply passage).

Still another fuel cell system according to the present invention includes: a supply piping extending from a fuel gas supply source to a gas inlet of a fuel cell; and a circulation piping extending from a gas outlet of the fuel cell to a junction at which the circulation piping joins the supply piping and causing anode off-gas discharged from the fuel cell to flow into fuel gas from the fuel gas supply source. A regulating valve and a shut-off valve in order from the fuel gas supply source side are provided on the upstream side of the junction in the supply piping; and any switch devices for opening and closing these piping systems are not provided on a portion on the downstream side of the junction in the supply piping and the circulation piping.

According to the fuel cell system of the present invention as described above, it is possible to achieve a simple configuration and to appropriately reduce the amount of consumption of fuel gas while suitably circulating the fuel gas at the end of the operation or the like.

### BRIEF DESCRIPTION OF THE DRAWINGS

FIG. 1 is a block diagram showing the configuration of a fuel cell system according to an embodiment;

FIG. 2 is a block diagram showing the configuration of a conventional fuel cell system according to a comparative example; and

FIG. 3 is a block diagram showing the configuration of a fuel cell system according to another embodiment.

### BEST MODE FOR CARRYING OUT THE INVENTION

A fuel cell system according to a preferred embodiment of the present invention will be described below with reference to accompanying drawings.

The fuel cell system is simplified in system configuration by improving the arrangement of the switch devices such as valves disposed in a piping line for hydrogen gas as fuel gas. Furthermore, the fuel cell system is designed to reduce the amount of consumption of the hydrogen gas at the end of the system operation.

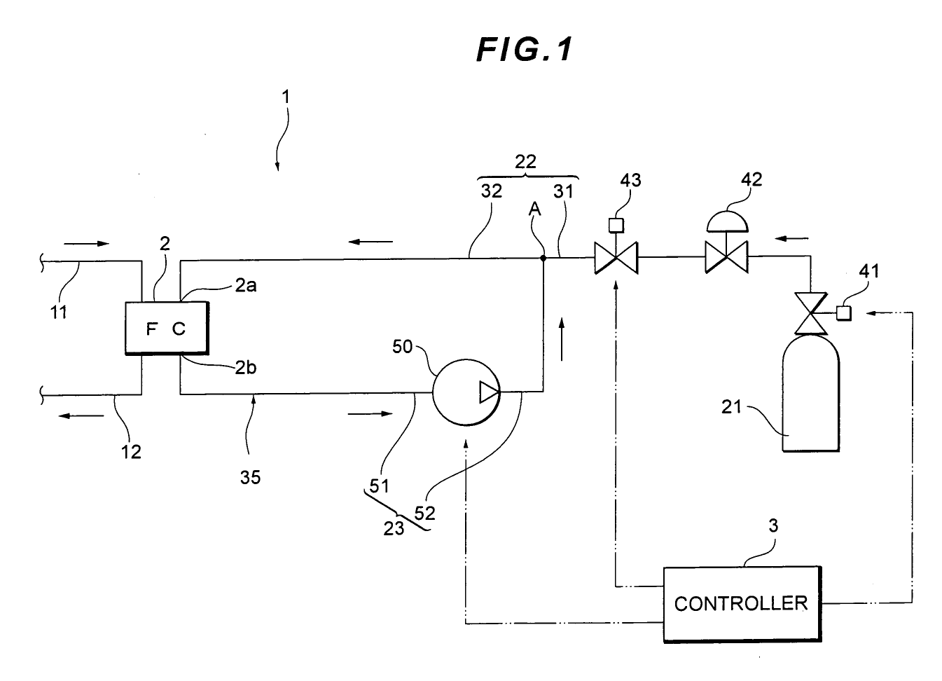

As shown in FIG. 1, the fuel cell system 1, which is mounted on, for example a fuel cell vehicle, includes a fuel cell 2 having a stack structure in which a lot of single cells are stacked and a controller 3 for overall controlling the entire system. As for the fuel cell 2, there are several types of fuel cells including a phosphoric-acid type. The fuel cell 2, however, is of solid polymer electrolyte type, which is suitable for in-vehicle and stationary applications here.

The single cell in the fuel cell 2, which is not shown, is composed of a membrane electrode assembly (MEA) interposed between a pair of separators made of metal or the like. The MEA includes a cathode supplied with air as oxidant gas, an anode supplied with hydrogen gas as fuel gas, and a polymer electrolyte membrane provided between the cathode and the anode. Normally, an air flow path is formed on the inner surface of one of the pair of separators, and a hydrogen gas flow path is formed on the inner surface of the other separator. The fuel cell 2 generates electricity using air and hydrogen gas, by which an electromotive force is obtained.

Air is pressure-fed by a compressor, which is not shown, and then supplied to the fuel cell 2 via a supply piping 11. Air (cathode off-gas) discharged from the fuel cell 2 is discharged to the outside via a discharge piping 12.

Hydrogen gas is stored in a fuel gas supply source 21. The fuel gas supply source 21 includes, for example, a tank (a pressure vessel) having a hydrogen storage alloy inside or a high pressure tank (a pressure vessel) for storing hydrogen gas at high pressure of 35 MPa or 70 MPa. Alternatively, the fuel gas supply source 21 includes a pressure vessel for storing a raw fuel such as compressed natural gas (CNG) at 20 MPa. In this case, the fuel cell vehicle is provided with a reformer for reforming the raw fuel to hydrogen gas.

The piping lines for the hydrogen gas includes a supply piping 22 extending from the fuel gas supply source 21 to an anode gas inlet 2a and a circulation piping 23 extending from an anode gas outlet 2b of the fuel cell 2 to a junction A at which the circulation piping 23 joins the supply piping 22. The circulation piping 23 causes un-reacted hydrogen gas (anode off-gas) which has been discharged from the fuel cell 2 to flow into new hydrogen gas from the fuel gas supply source 21. The mixed gas after the interflow is supplied to the fuel cell 2.

The supply piping 22 includes mainly an upstream pipe 31, which extends from the fuel gas supply source 21 to the junction A and through which new hydrogen gas flows, and a downstream pipe 32, which extends from the junction A to the anode gas inlet 2a of the fuel cell 2 and through which the mixed hydrogen gas flows. The anode gas outlet 2b and the anode gas inlet 2a of the fuel cell 2 are connected to each other by means of the downstream pipe 32 (a first circulation path) and the circulation piping 23 (a second circulation path) to thereby form a gas circulation system 35 for circulating hydrogen gas from the fuel cell 2 to the fuel cell 2. The upstream pipe 31 (a first supply passage) is connected at the junction A (connecting point) of the gas circulation system 35.

The upstream pipe 31 is provided with a shut-off valve 41 (a second shut-off valve), which is a source valve for the fuel gas supply source 21, a regulating valve 42, which is located on the downstream side of the shut-off valve 41, and a shut-off valve 43 (a first shut-off valve), which is located on the downstream side of the regulating valve 42.

The regulating valve 42 (regulator) reduces the pressure of hydrogen gas from the fuel gas supply source 21 to regulate the pressure of hydrogen gas supplied to the fuel cell 2. While one regulating valve 42 is disposed in the upstream pipe 31 in this embodiment, it is preferable to reduce the pressure of hydrogen gas from the fuel gas supply source 21 gradually by disposing a plurality of regulating valves 42 in the upstream pipe 31. For example, the hydrogen gas pressure is regulated to 0.2 MPa to 0.3 MPa finally by disposing two regulating valves 42. Naturally, all of the regulating valves 42 are disposed on the upstream side of the shut-off valve 43 near the junction A and on the downstream side of the shut-off valve 41 which is the source valve.

The two shut-off valves 41 and 43 are each composed of, for example, a solenoid valve connected to the controller 3 and controlled to open and close by the controller 3. The shut-off valve 43 is located on the upstream side of the junction A nearest thereto, having a backflow prevention function. The opening of the shut-off valves 41 and 43 allow the supply of hydrogen gas in the upstream pipe 31 to the fuel cell 2. The closing of the shut-off valves 41 and 43 stops the supply of the hydrogen gas in the upstream pipe 31 to the fuel cell 2. In this situation, a closed space (closed circuit) between the shut-off valve 43 and the fuel cell 2 is formed by a portion of the upstream pipe 31 from the shut-off valve 43 to the junction A and the gas circulation system 35.

The circulation piping 23 is provided with a pump 50 for pressure- feeding hydrogen gas. The circulation piping 23 includes mainly a first piping 51 extending from the anode gas outlet 2b of the fuel cell 2 to the pump 50 and a second piping 52 extending from the pump 50 to the junction. The pump 50 has a motor to be its driving source connected to the controller 3, so that the controller 3 controls the RPM of the motor.

The circulation piping 23 is not provided with any switch devices for opening and closing it. While the term “switch device” here means mainly a shut-off valve, it also includes a check valve which is closed to stop a reverse flow of hydrogen gas. This type of switch device is not disposed in the circulation piping 23 and in the downstream pipe 32 of the supply piping 22.

More specifically, the gas circulation system 35 does not include any switch devices. In other words, the gas circulation system 35 is arranged so that the passage (the circulation piping 23 and the downstream pipe 32) is kept in constant communication between the anode gas outlet 2b and the anode gas inlet 2a also when operating and stopping the fuel cell system 1. The term “in communication” means a state in which the insides of the circulation piping 23 and the downstream pipe 32 are not completely closed and gas can flow through the inside thereof.

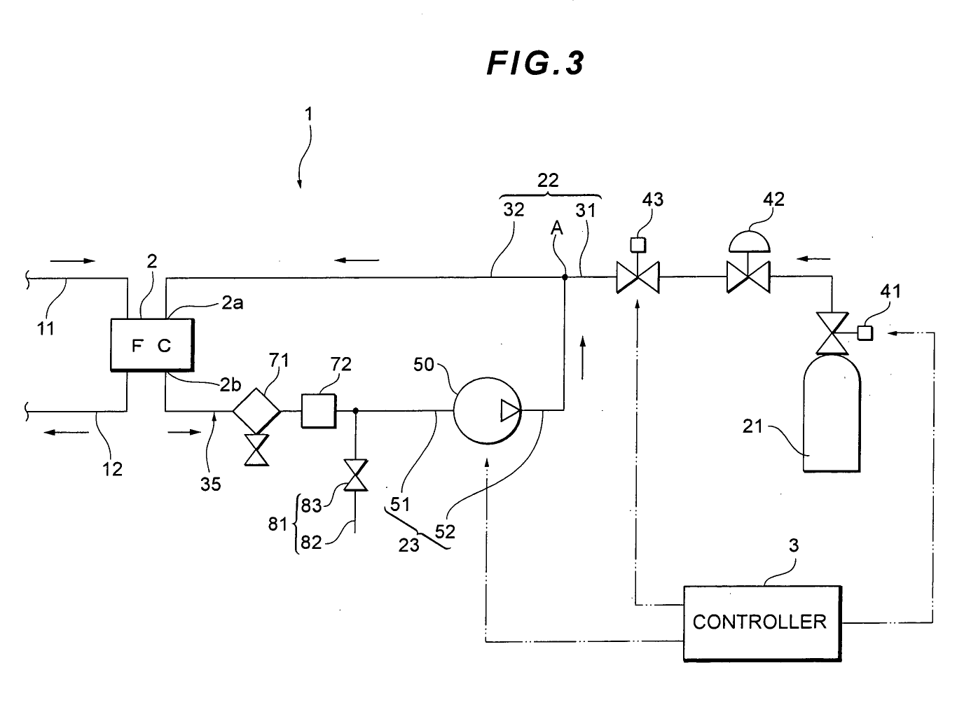

As another embodiment of the present invention, it is also possible to use a system configuration as shown in FIG. 3.

More specifically, as shown in FIG. 3, the circulation piping 23 can be provided with a gas-liquid separator 71 for separating hydrogen gas discharged from the fuel cell 2 into liquid and gas components. In addition, the circulation piping 23 can be provided with an impurity remover 72 such as an ion exchanger for removing impurity components contained in hydrogen gas. The gas-liquid separator 71 and the ion exchanger 72 are not configured to open and close the circulation piping 23. More specifically, the gas-liquid separator 71 and the impurity remover 72 are not configured to prevent the circulation piping 23 from being in communication therein. Specifically, the gas-liquid separator 71 is, for example, a cyclone separator, which is not configured to close the gas passage in the gas-liquid separator 71. The impurity remover 72 is, for example, a mesh filter or a case having ion exchange resin sealed therein through which the gas can flow. The impurity remover 72 is similarly not configured to close the gas passage, either.

Furthermore, as shown in FIG. 3, there can be provided a purge system 81 branch-connected to, for example, the first piping 51 or the second piping 52 of the circulation piping 23. The purge system 81 is for use in discharging impurities contained in hydrogen gas to the outside together with hydrogen gas. Preferably, the purge system 81 includes a purge passage 82 connected to the first piping 51, and a purge valve 83 of a shut-off valve type for opening and closing the purge passage 82. More preferably, the gas-liquid separator 71, a connecting point of the purge passage 82, and the pump 50 are disposed in this order from the anode gas outlet 2b toward the downstream on the first piping 51 between the anode gas outlet 2b and the pump 50.

The controller 3 (ECU) has a CPU which is not shown, a ROM which stores a control program and control data to be processed by the CPU, and a RAM which is used as various working areas mainly for control processing. The controller 3 enters detection signals from a temperature sensor, a pressure sensor, and other various sensors which are not shown. In addition, the controller 3 overall controls the entire fuel cell system 1 with controlling the pump 50 and the shut-off valves 41 and 43 by outputting control signals to various drivers or the like.

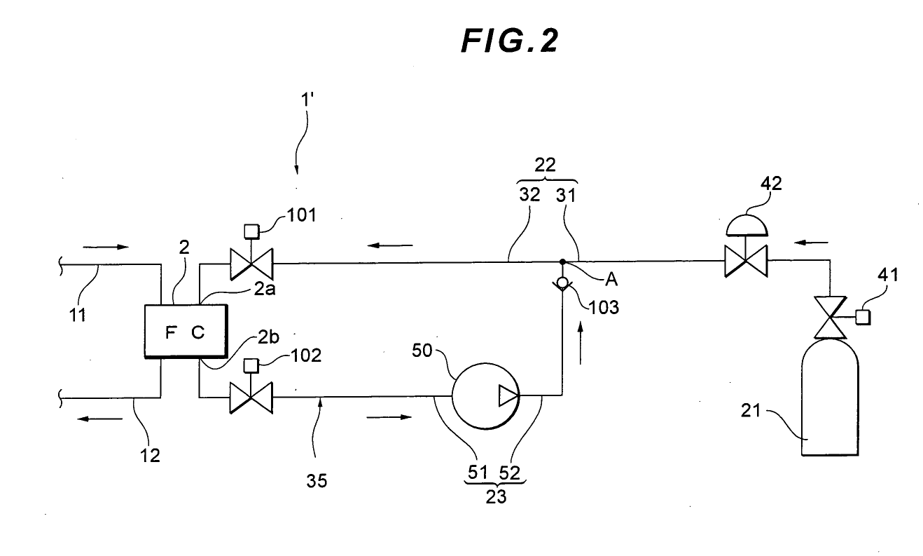

The effects of the fuel cell system 1 in this embodiment will be described in comparison with the conventional fuel cell system 1′ shown in FIG. 2. In FIG. 2, the same reference numerals denote the same components as those of the fuel cell system 1 in this embodiment.

As shown in FIG. 2, the downstream pipe 32 of the supply piping 22 and the first piping 51 of the circulation piping 23 in the gas circulation system 35 are provided with shut-off valves 101 and 102, respectively. In addition, the second piping 52 of the circulation piping 23 is provided with a check valve 103. Furthermore, the upstream pipe 31 of the supply piping 22 is not provided with a shut-off valve between the regulating valve 42 and the junction A.

The conventional fuel cell system 1′ includes the two shut-off valves 101 and 102 and the check valve 103 in the gas circulation system 35. On the other hand, the fuel cell system 1 of this embodiment not including these valves can reduce costs by just that much by decreasing the number of parts.

Generally, there is a potential for impurity components or foreign matters, which can flow out of or elute from the piping or the fuel cell 2, to flow inside the piping in the gas circulation system 35. In the conventional fuel cell system 1′, the impurity components or the like can inhibit the functions of the shut-off valves 101 and 102 or the like. On the other hand, according to the fuel cell system 1 of this embodiment, the decrease in the number of parts prevents the functions from being inhibited, thereby increasing the reliability of the system.

Furthermore, when operating the conventional fuel cell system 1′, a pressure loss of hydrogen gas occurs in the two shut-off valves 101 and 102 and the check valve 103 in the gas circulation system 35. For this reason, it is necessary to drive the pump 50 regulated in the RPM in consideration of the pressure loss. On the other hand, the gas circulation system 35 is not provided with these switch devices in the fuel cell system 1 of this embodiment and therefore it can suppress the pressure loss of the hydrogen gas. Accordingly, the control of the pump 50 is simplified and the power consumption can be reduced.

Furthermore, generally it is preferable that the differential pressure between the anode and the cathode is low after completion of the operation of the fuel cell system (1,1′). Therefore, at the end of the operation just before the transition to the shutdown of the fuel cell system (1,1′), the pump 50 continues to be driven for a predetermined time period to consume hydrogen gas by power generation of the fuel cell 2.

In the conventional fuel cell system 1′, the pump 50 cannot continue to be driven after the closing of the two shut-off valves 101 and 102 in the gas circulation system 35 at the end of the operation. Therefore, it becomes difficult to carry out the power generation of the fuel cell 2 at the pressure during the rated operation or lower. In addition, when the pump 50 is driven with the two shut-off valves 101 and 102 opened, there is a need to consume the hydrogen gas in the upstream pipe 31 as well as the hydrogen gas in the gas circulation system 35.

On the other hand, in the fuel cell system 1 of this embodiment, the gas circulation system 35 is in constant communication and therefore the pump 50 can continue to be driven without fail at the end of the operation. Furthermore, hydrogen gas in the gas circulation system 35 can be consumed without consumption of hydrogen gas in the upstream pipe 31 by closing the shut-off valve 43 nearest to the junction. In other words, it is possible to reduce the amount of consumption of hydrogen gas at the end of the operation by the amount of decrease in hydrogen gas remaining in the closed space. Therefore, it is possible to improve the fuel consumption (generating efficiency) by stabilizing the power generation of the fuel cell 2 at the pressure during the rated operation or lower. Moreover, this reduces the operation completion time and appropriately prevents overcharge of the secondary battery which is not shown.

1. A fuel cell system having as piping lines for fuel gas:
a gas circulation system connecting a gas outlet of a fuel cell to a gas inlet of the fuel, the gas circulation system circulating fuel gas from the fuel cell to the fuel cell; and
a first supply passage through which new fuel gas flows from a fuel gas supply source, the first supply passage connected to the gas circulation system, the fuel cell system comprising:
a regulating valve disposed in the first supply passage;
at least one shut-off valve disposed only in the first supply passage among the piping lines and located on the downstream side of the regulating valve; and
a pump for pressure-feeding fuel gas, the pump disposed in the gas circulation system; and
a controller for controlling the pump and the at least one shut-off valve,
wherein the controller continues to drive the pump after closing the at least one shut-off valve and causes fuel gas in the gas circulation system to be consumed by power generation of the fuel cell at the end of the operation of the fuel cell system.

2. A fuel cell system according to claim 1, wherein the gas circulation system has a passage in constant communication between the gas outlet and the gas inlet of the fuel cell.

3. A fuel cell system comprising as piping lines for fuel gas:
a gas circulation system connecting a gas outlet of a fuel cell to a gas inlet of the fuel, the gas circulation system circulating fuel gas from the fuel cell to the fuel cell; and
a first supply passage through which new fuel gas flows from a fuel gas supply source, the first supply passage connected to the gas circulation system, the fuel cell system comprising:
a regulating valve and at least one shut-off valve disposed in order from the fuel gas supply source side in the first supply passage;
a pump for pressure-feeding fuel gas, the pump disposed in the gas circulation system; and
a controller for controlling the pump and the at least one shut-off valve,
wherein the gas circulation system has a passage in constant communication between the gas outlet and the gas inlet of the fuel cell; and
wherein the controller continues to drive the pump after closing the at least one shut-off valve and causes fuel gas in the gas circulation system to be consumed by power generation of the fuel cell at the end of the operation of the fuel cell system.

4. A fuel cell system according to claim 3, wherein the gas circulation system has the passage in communication between the gas outlet and the gas inlet of the fuel cell when operating and stopping the fuel cell system.

5. (canceled)

6. A fuel cell system according to claim 1, wherein the at least one shut-off valve is disposed near a connecting point between the gas circulation system and the first supply passage.

7. A fuel cell system according to claim 1, wherein the fuel gas supply source is a pressure vessel storing hydrogen gas as fuel gas.

8. A fuel cell system according to claim 1, wherein the at least one shut-off valve includes:
a first shut-off valve disposed on the downstream side of the regulating valve in the first supply passage; and
a second shut-off valve disposed between the regulating valve and the fuel gas supply source.

9. A fuel cell system according to claim 8, wherein the second shut-off valve is a source valve for the fuel gas supply source.

10. A fuel cell system according to claim 1, wherein a plurality of regulating valves are disposed in the first supply passage by a plural number.

11. A fuel cell system according to claim 1, wherein the gas circulation system includes a gas-liquid separator for separating anode off-gas discharged from the fuel cell into liquid and gas components.

12. A fuel cell system according to claim 1, wherein the gas circulation system includes an impurity remover for removing impurity components contained in the anode off-gas discharged from the fuel cell.

13. A fuel cell system according to claim 1, wherein the gas circulation system composed of:
a first circulation path from the gas outlet to a connecting point with the first supply passage; and
a second circulation path from the connecting point to the gas inlet, the second circulation path communicated with the first circulation path.

14. A fuel cell system comprising:
a supply piping extending from a fuel gas supply source to a gas inlet of a fuel cell;
a circulation piping extending from a gas outlet of the fuel cell to a junction at which the circulation piping joins the supply piping, the circulation piping causing anode off-gas discharged from the fuel cell to flow into fuel gas from the fuel gas supply source
a shut-off valve disposed in the supply piping and located on the upstream side of the junction;
a regulating valve disposed in the supply piping and located on the upstream side of the shut-off valve;
a pump for pressure-feeding anode off-gas, the pump disposed in the circulation piping; and
a controller for controlling the pump and the shut-off valve,
wherein a portion on the downstream side of the junction in the supply piping and the circulation piping are in constant communication; and
wherein the controller continues to drive the pump after closing the shut-off valve and causes fuel gas in the piping on the downstream side of the shut-off valve to be consumed by power generation of the fuel cell at the end of the operation of the fuel cell system.

15. A fuel cell system according to claim 14, wherein the portion on the downstream side of the junction in the supply piping and the circulation piping are communicated when operating and stopping the fuel cell system.

16. A fuel cell system according to claim 14, wherein the portion on the downstream side of the junction in the supply piping and the circulation piping are not provided with any switch devices for opening and closing the supply piping and the circulation piping.

17. (canceled)

18. A fuel cell system according to claim 14, wherein the shut-off valve is disposed near the junction.
